(19) United States
(12) Patent Application Publication
(10) Pub. No.: US 2013/0226804 A1
(43) Pub. Date: Aug. 29, 2013

(54) MULTI-SOURCE DEBIT CARD OBJECT ORIENTED SYSTEM AND METHOD

(71) Applicant: Weiss Enterprises, Inc., (US)

(72) Inventor: Jessica M. Weiss, Wabash, IN (US)

(73) Assignee: Weiss Enterprises, Inc., Wabash, IN (US)

(21) Appl. No.: 13/779,970

(22) Filed: Feb. 28, 2013

Related U.S. Application Data
(63) Continuation-in-part of application No. 13/681,783, filed on Nov. 20, 2012.
(60) Provisional application No. 61/604,357, filed on Feb. 28, 2012.

(51) Int. Cl. G06Q 20/34

(52) U.S. Cl. CPC G06Q 20/349
USPC 705/44; 705/39

(57) ABSTRACT

The present invention involves a server based system and method which enables multiple source reloading of a single debit card. The multiple-source debit card system and method allows multiple individuals to provide funds to a single debit card without the multiple individuals needing to know any bank account information. Multiple sources, optionally identified through a multi-factor identification may reload the account associated with the debit card. Alternatively, a closed loop debit card may be funded from multiple sources. The system and method identifies the participants for purposes of the financial transaction, although the identification of the recipient may be managed by the donor.

### CROSS REFERENCE TO RELATED APPLICATIONS

The present application claims priority under 35 U.S.C. §119(e) of U.S. Provisional Patent Application Ser. No. 61/604,357; filed on Feb. 28, 2012, and titled the same as the present application, and under 35 U.S.C. §120 of U.S. patent application Ser. No. 13/681,783; filed Nov. 20, 2012, and titled “MULTI-SOURCE DEBIT CARD SYSTEM AND METHOD”; the disclosures of which are expressly incorporated by reference herein.

### BACKGROUND OF THE INVENTION

1. Field of the Invention

The invention relates to financial transaction software. More specifically, the field of the invention is that of financial transaction software for the debit card industry.

2. Description of the Related Art

Debit cards are a financial transaction card that allows a user to directly transfer money for a purchase to a vendor. Used much like a credit card, the debit card differs in that there is an immediate transfer of funds, wherein the credit card payment does not transfer funds until the charge card bill is paid.

The debit card is typically funded through a bank account. The owner of the bank account may reload a debit card by depositing more funds into the connected bank account. Gift cards have been developed that function similar to a debit card, but which are funded by the transfer of funds from the gift card purchaser to the financial institution sponsoring the gift card. In this way, a person may provide a cash-like gift card to another person. Some gift cards are reloadable, that is they allow further funds to be associated with the card.

In financial transactions, it is important to identify the participants in the financial transaction, regardless of whether the form of the financial instrument is a check, money order, or other instrument. Typically, with those written instruments, the participants are determined by conventional identification (i.e., driver's license or passport). In electronic transactions, however, the problem of identification of participants is complicated by the mediums involved. Thus, many financial instruments are limited in their application to electronic commerce. Furthermore, there is a technical problem in providing a system and method able to permit the funding of a debit card from multiple sources, as well in identifying those multiple sources in an e-commerce environment.

### SUMMARY OF THE INVENTION

The present invention is a multiple-source debit card system and method which allows multiple individuals to provide funds to a single debit card without the multiple individuals needing to know any bank account information. In one embodiment, multiple sources may reload the account associated with the debit card. In another embodiment, a closed loop debit card may be funded from multiple sources. The system and method identifies the participants for purposes of the financial transaction, although the disclosure of the identification may be managed by the donor.

In several embodiments, identity modules are used to identify the sources of funds. Such identity modules may come from several sources, including an independent web site, a social network and its credentialing of its members, a financial institution, and/or an independent identity service. In these several embodiments, the identity module provides verification of the source of the funds, and may provide the funds as well. By having identity modules to determine the source of the funds, the financial institutions involved may satisfy accounting and regulatory compliance as a matter of routine and provide the underlying framework for the open or closed loop multiple-sourced debit card.

In some embodiments, the entire transaction may appear to occur on a social network or other internet location without the need to explicitly contact a financing organization. In one embodiment, the identity module has financial transaction information for each individual so that a button may be added to a social media member's individual page so that any member of the social network can contribute to the funding. For example, a group may be created on a social network, and one of the group members has a financial need. Any group member may start the reloadable debit card, and then explain in a post with the button the nature of the fund raising. Then, any member of the group wanting to contribute may hit the button and indicate the amount to contribute. In cases where the social network identity module does not have all the identity information it may have enough information to send an e-mail, text, or other message to the user to instruct the user on completing the financial aspect of the transaction.

In embodiments of the invention, subsystems of the system and process of the multi-source reloadable debit card may be performed in separate and distinct modules. Such modules may be located in one or several physical locations and machines, coupled by communications links.

### BRIEF DESCRIPTION OF THE DRAWINGS

The above mentioned and other features and objects of this invention, and the manner of attaining them, will become more apparent and the invention itself will be better understood by reference to the following description of an embodiment of the invention taken in conjunction with the accompanying drawings, wherein:

FIG. 1 is a schematic diagrammatic view of a network system in which embodiments of the present invention may be utilized.

FIG. 2 is a block diagram of a computing system (either a server or client, or both, as appropriate), with optional input devices (e.g., keyboard, mouse, touch screen, etc.) and output devices, hardware, network connections, one or more processors, and memory/storage for data and modules, etc. which may be utilized in conjunction with embodiments of the present invention.

FIG. 3 is a schematic diagram of the operation of the present invention relating to multiple sources funding a debit card through a web site.

FIG. 4, comprising FIGS. 4A and 4B, is a schematic work flow diagram of the funding of a debit card according to embodiments of the present invention.

FIG. 5 is a graphic representation of a situation where embodiments of a multi-source reloadable debit card of the present invention could be used.

FIG. 6 is a schematic diagram representation of the use of an embodiment of the present invention through a social network.

FIG. 7 is a illustration of one embodiment of the invention in the form of a kit.

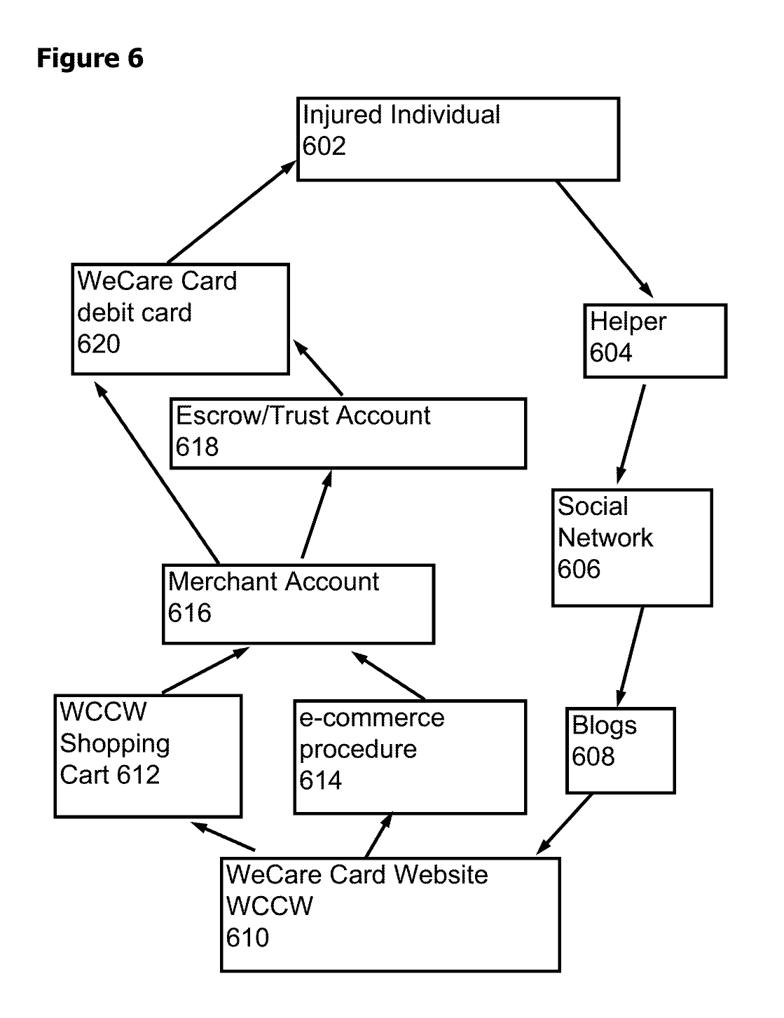

FIG. 8 is a schematic diagram of the operation of one embodiment of the present invention relating to multiple sources funding a debit card through a call center.

FIG. 9 is a schematic diagram of the operation of one embodiment of the present invention relating to multiple sources funding a debit card through a kiosk.

Corresponding reference characters indicate corresponding parts throughout the several views. Although the drawings represent embodiments of the present invention, the drawings are not necessarily to scale and certain features may be exaggerated in order to better illustrate and explain the present invention. The flow charts and screen shots are also representative in nature, and actual embodiments of the invention may include further features or steps not shown in the drawings. The exemplification set out herein illustrates an embodiment of the invention, in one form, and such exemplifications are not to be construed as limiting the scope of the invention in any manner.

### DESCRIPTION OF EMBODIMENTS OF THE PRESENT INVENTION

The embodiment disclosed below is not intended to be exhaustive or limit the invention to the precise form disclosed in the following detailed description. Rather, the embodiment is chosen and described so that others skilled in the art may utilize its teachings.

The detailed descriptions which follow are presented in part in terms of algorithms and symbolic representations of operations on data bits within a computer memory representing alphanumeric characters or other information. A computer generally includes a processor for executing instructions and memory for storing instructions and data. When a general purpose computer has a series of machine encoded instructions stored in its memory, the computer operating on such encoded instructions may become a specific type of machine, namely a computer particularly configured to perform the operations embodied by the series of instructions. Some of the instructions may be adapted to produce signals that control operation of other machines and thus may operate through those control signals to transform materials far removed from the computer itself. These descriptions and representations are the means used by those skilled in the art of data processing arts to most effectively convey the substance of their work to others skilled in the art.

An algorithm is here, and generally, conceived to be a self-consistent sequence of steps leading to a desired result. These steps are those requiring physical manipulations of physical quantities. Usually, though not necessarily, these quantities take the form of electrical or magnetic pulses or signals capable of being stored, transferred, transformed, combined, compared, and otherwise manipulated. It proves convenient at times, principally for reasons of common usage, to refer to these signals as bits, values, symbols, characters, display data, terms, numbers, or the like as a reference to the physical items or manifestations in which such signals are embodied or expressed. It should be borne in mind, however, that all of these and similar terms are to be associated with the appropriate physical quantities and are merely used here as convenient labels applied to these quantities.

Some algorithms may use data structures for both inputting information and producing the desired result. Data structures greatly facilitate data management by data processing systems, and are not accessible except through sophisticated software systems. Data structures are not the information content of a memory, rather they represent specific electronic structural elements which impart or manifest a physical organization on the information stored in memory. More than mere abstraction, the data structures are specific electrical or magnetic structural elements in memory which simultaneously represent complex data accurately, often data modeling physical characteristics of related items, and provide increased efficiency in computer operation.

Further, the manipulations performed are often referred to in terms, such as comparing or adding, commonly associated with mental operations performed by a human operator. No such capability of a human operator is necessary, or desirable in most cases, in any of the operations described herein which form part of the present invention; the operations are machine operations. Useful machines for performing the operations of the present invention include general purpose digital computers or other similar devices. In all cases the distinction between the method operations in operating a computer and the method of computation itself should be recognized. The present invention relates to a method and apparatus for operating a computer in processing electrical or other (e.g., mechanical, chemical) physical signals to generate other desired physical manifestations or signals. The computer operates on software modules, which are collections of signals stored on a media that represents a series of machine instructions that enable the computer processor to perform the machine instructions that implement the algorithmic steps. Such machine instructions may be the actual computer code the processor interprets to implement the instructions, or alternatively may be a higher level coding of the instructions that is interpreted to obtain the actual computer code. The software module may also include a hardware component, wherein some aspects of the algorithm are performed by the circuitry itself rather as a result of an instruction.

The present invention also relates to an apparatus for performing these operations. This apparatus may be specifically constructed for the required purposes or it may comprise a general purpose computer as selectively activated or reconfigured by a computer program stored in the computer. The algorithms presented herein are not inherently related to any particular computer or other apparatus unless explicitly indicated as requiring particular hardware. In some cases, the computer programs may communicate or relate to other programs or equipments through signals configured to particular protocols which may or may not require specific hardware or programming to interact. In particular, various general purpose machines may be used with programs written in accordance with the teachings herein, or it may prove more convenient to construct more specialized apparatus to perform the required method steps. The required structure for a variety of these machines will appear from the description below.

The present invention may deal with “object-oriented” software, and particularly with an “object-oriented” operating system. The “object-oriented” software is organized into “objects”, each comprising a block of computer instructions describing various procedures (“methods”) to be performed in response to “messages” sent to the object or “events” which occur with the object. Such operations include, for example, the manipulation of variables, the activation of an object by an external event, and the transmission of one or more messages to other objects.

Messages are sent and received between objects having certain functions and knowledge to carry out processes. Messages are generated in response to user instructions, for example, by a user activating an icon with a “mouse” pointer generating an event. Also, messages may be generated by an object in response to the receipt of a message. When one of the objects receives a message, the object carries out an operation (a message procedure) corresponding to the message and, if necessary, returns a result of the operation. Each object has a region where internal states (instance variables) of the object itself are stored and where the other objects are not allowed to access. One feature of the object-oriented system is inheritance. For example, an object for drawing a “circle” on a display may inherit functions and knowledge from another object for drawing a “shape” on a display.

A programmer “programs” in an object-oriented programming language by writing individual blocks of code each of which creates an object by defining its methods. A collection of such objects adapted to communicate with one another by means of messages comprises an object-oriented program. Object-oriented computer programming facilitates the modeling of interactive systems in that each component of the system can be modeled with an object, the behavior of each component being simulated by the methods of its corresponding object, and the interactions between components being simulated by messages transmitted between objects.

An operator may stimulate a collection of interrelated objects comprising an object-oriented program by sending a message to one of the objects. The receipt of the message may cause the object to respond by carrying out predetermined functions which may include sending additional messages to one or more other objects. The other objects may in turn carry out additional functions in response to the messages they receive, including sending still more messages. In this manner, sequences of message and response may continue indefinitely or may come to an end when all messages have been responded to and no new messages are being sent. When modeling systems utilizing an object-oriented language, a programmer need only think in terms of how each component of a modeled system responds to a stimulus and not in terms of the sequence of operations to be performed in response to some stimulus. Such sequence of operations naturally flows out of the interactions between the objects in response to the stimulus and need not be preordained by the programmer.

Although object-oriented programming makes simulation of systems of interrelated components more intuitive, the operation of an object-oriented program is often difficult to understand because the sequence of operations carried out by an object-oriented program is usually not immediately apparent from a software listing as in the case for sequentially organized programs. Nor is it easy to determine how an object-oriented program works through observation of the readily apparent manifestations of its operation. Most of the operations carried out by a computer in response to a program are “invisible” to an observer since only a relatively few steps in a program typically produce an observable computer output.

In the following description, several terms which are used frequently have specialized meanings in the present context. The term “object” relates to a set of computer instructions and associated data which can be activated directly or indirectly by the user. The terms “windowing environment”, “running in windows”, and “object oriented operating system” are used to denote a computer user interface in which information is manipulated and displayed on a video display such as within bounded regions on a raster scanned video display. The terms “network”, “local area network”, “LAN”, “wide area network”, or “WAN” mean two or more computers which are connected in such a manner that messages may be transmitted between the computers. In such computer networks, typically one or more computers operate as a “server”, a computer with large storage devices such as hard disk drives and communication hardware to operate peripheral devices such as printers or modems. Other computers, termed “workstations”, provide a user interface so that users of computer networks can access the network resources, such as shared data files, common peripheral devices, and inter-workstation communication. Users activate computer programs or network resources to create “processes” which include both the general operation of the computer program along with specific operating characteristics determined by input variables and its environment. Similar to a process is an agent (sometimes called an intelligent agent), which is a process that gathers information or performs some other service without user intervention and on some regular schedule. Typically, an agent, using parameters typically provided by the user, searches locations either on the host machine or at some other point on a network, gathers the information relevant to the purpose of the agent, and presents it to the user on a periodic basis.

The term “desktop” means a specific user interface which presents a menu or display of objects with associated settings for the user associated with the desktop. When the desktop accesses a network resource, which typically requires an application program to execute on the remote server, the desktop calls an Application Program Interface, or “API”, to allow the user to provide commands to the network resource and observe any output. The term “Browser” refers to a program which is not necessarily apparent to the user, but which is responsible for transmitting messages between the desktop and the network server and for displaying and interacting with the network user. Browsers are designed to utilize a communications protocol for transmission of text and graphic information over a world wide network of computers, namely the “World Wide Web” or simply the “Web”. Examples of Browsers compatible with the present invention include the Chrome browser program developed by Google Inc. of Mountain View, California (Chrome is a trademark of Google Inc.), the Safari browser program developed by Apple Inc. of Cupertino, Calif. (Safari is a registered trademark of Apple Inc.), Internet Explorer program developed by Microsoft Corporation (Internet Explorer is a trademark of Microsoft Corporation), the Opera browser program created by Opera Software ASA, or the Firefox browser program distributed by the Mozilla Foundation (Firefox is a registered trademark of the Mozilla Foundation). Although the following description details such operations in terms of a graphic user interface of a Browser, the present invention may be practiced with text based interfaces, or even with voice or visually activated interfaces, that have many of the functions of a graphic based Browser.

Browsers display information which is formatted in a Standard Generalized Markup Language (“SGML”) or a HyperText Markup Language (“HTML”), both being scripting languages which embed non-visual codes in a text document through the use of special ASCII text codes. Files in these formats may be easily transmitted across computer networks, including global information networks like the Internet, and allow the Browsers to display text, images, and play audio and video recordings. The Web utilizes these data file formats to conjunction with its communication protocol to transmit such information between servers and workstations. Browsers may also be programmed to display information provided in an eXtensible Markup Language (“XML”) file, with XML files being capable of use with several Document Type Definitions (“DTD”) and thus more general in nature than SGML or HTML. The XML file may be analogized to an object, as the data and the stylesheet formatting are separately contained (formatting may be thought of as methods of displaying information, thus an XML file has data and an associated method).

The terms “personal digital assistant” or “PDA”, as defined above, means any handheld, mobile device that combines computing, telephone, fax, e-mail and networking features. The terms “wireless wide area network” or “WWAN” mean a wireless network that serves as the medium for the transmission of data between a handheld device and a computer. The term “synchronization” means the exchanging of information between a first device, e.g. a handheld device, and a second device, e.g. a desktop computer, either via wires or wirelessly. Synchronization ensures that the data on both devices are identical (at least at the time of synchronization).

In wireless wide area networks, communication primarily occurs through the transmission of radio signals over analog, digital cellular or personal communications service (“PCS”) networks. Signals may also be transmitted through microwaves and other electromagnetic waves. At the present time, most wireless data communication takes place across cellular systems using second generation technology such as code-division multiple access (“CDMA”), time division multiple access (“TDMA”), the Global System for Mobile Communications (“GSM”), Third Generation (wideband or “3G”), Fourth Generation (broadband or “4G”), personal digital cellular (“PDC”), or through packet-data technology over analog systems such as cellular digital packet data (CDPD”) used on the Advance Mobile Phone Service (“AMPS”).

The terms “wireless application protocol” or “WAP” mean a universal specification to facilitate the delivery and presentation of web-based data on handheld and mobile devices with small user interfaces. “Mobile Software” refers to the software operating system which allows for application programs to be implemented on a mobile device such as a mobile telephone or PDA. Examples of Mobile Software are Java and Java ME (Java and JavaME are trademarks of Sun Microsystems, Inc. of Santa Clara, California), BREW (BREW is a registered trademark of Qualcomm Incorporated of San Diego, California), Windows Mobile (Windows is a registered trademark of Microsoft Corporation of Redmond, Washington), Palm OS (Palm is a registered trademark of Palm, Inc. of Sunnyvale, Calif.), Symbian OS (Symbian is a registered trademark of Symbian Software Limited Corporation of London, United Kingdom), ANDROID OS (ANDROID is a registered trademark of Google, Inc. of Mountain View, Calif.), and iPhone OS (iPhone is a registered trademark of Apple, Inc. of Cupertino, Calif.), and Windows Phone 7. “Mobile Apps” refers to software programs written for execution with Mobile Software.

In the following specification, the term “social network” may be used to refer to a multiple user computer software system that allows for relationships among and between users (individuals or members) and content assessable by the system. Generally, a social network is defined by the relationships among groups of individuals, and may include relationships ranging from casual acquaintances to close familial bonds. In addition, members may be other entities that may be linked with individuals. The logical structure of a social network may be represented using a graph structure. Each node of the graph may correspond to a member of the social network, or content assessable by the social network. Edges connecting two nodes represent a relationship between two individuals. In addition, the degree of separation between any two nodes is defined as the minimum number of hops required to traverse the graph from one node to the other. A degree of separation between two members is a measure of relatedness between the two members.

Social networks may comprise any of a variety of suitable arrangements. An entity or member of a social network may have a profile and that profile may represent the member in the social network. The social network may facilitate interaction between member profiles and allow associations or relationships between member profiles. Associations between member profiles may be one or more of a variety of types, such as friend, co-worker, family member, business associate, common-interest association, and common-geography association. Associations may also include intermediary relationships, such as friend of a friend, and degree of separation relationships, such as three degrees away. Associations between member profiles may be reciprocal associations. For example, a first member may invite another member to become associated with the first member and the other member may accept or reject the invitation. A member may also categorize or weigh the association with other member profiles, such as, for example, by assigning a level to the association. For example, for a friendship-type association, the member may assign a level, such as acquaintance, friend, good friend, and best friend, to the associations between the member's profile and other member profiles.

Each profile within a social network may contain entries, and each entry may comprise information associated with a profile. Examples of entries for a person profile may comprise contact information such as an email addresses, mailing address, instant messaging (or IM) name, or phone number; personal information such as relationship status, birth date, age, children, ethnicity, religion, political view, sense of humor, sexual orientation, fashion preferences, smoking habits, drinking habits, pets, hometown location, passions, sports, activities, favorite books, music, TV, or movie preferences, favorite cuisines; professional information such as skills, career, or job description; photographs of a person or other graphics associated with an entity; or any other information or documents describing, identifying, or otherwise associated with a profile. Entries for a business profile may comprise industry information such as market sector, customer base, location, or supplier information; financial information such as net profits, net worth, number of employees, stock performance; or other types of information and documents associated with the business profile.

A member profile may also contain rating information associated with the member. For example, the member may be rated or scored by other members of the social network in specific categories, such as humor, intelligence, fashion, trustworthiness, sexiness, and coolness. A member's category ratings may be contained in the member's profile. In one embodiment of the social network, a member may have fans. Fans may be other members who have indicated that they are “fans” of the member. Rating information may also include the number of fans of a member and identifiers of the fans. Rating information may also include the rate at which a member accumulated ratings or fans and how recently the member has been rated or acquired fans.

A member profile may also contain social network activity data associated with the member. Membership information may include information about a member's login patterns to the social network, such as the frequency that the member logs in to the social network and the member's most recent login to the social network. Membership information may also include information about the rate and frequency that a member profile gains associations to other member profiles. In a social network that comprises advertising or sponsorship, a member profile may contain consumer information. Consumer information may include the frequency, patterns, types, or number of purchases the member makes, or information about which advertisers or sponsors the member has accessed, patronized, or used.

A member profile may comprise data stored in memory. The profile, in addition to comprising data about the member, may also comprise data relating to others. For example, a member profile may contain an identification of associations or virtual links with other member profiles. In one embodiment, a member's social network profile may comprise a hyperlink associated with another member's profile. In one such association, the other member's profile may contain a reciprocal hyperlink associated with the first member's profile. A member's profile may also contain information excerpted from another associated member's profile, such as a thumbnail image of the associated member, his or her age, marital status, and location, as well as an indication of the number of members with which the associated member is associated. In one embodiment, a member's profile may comprise a list of other social network members' profiles with which the member wishes to be associated.

An association may be designated manually or automatically. For example, a member may designate associated members manually by selecting other profiles and indicating an association that may be recorded in the member's profile. According to one embodiment, associations may be established by an invitation and an acceptance of the invitation. For example, a first user may send an invitation to a second user inviting the second user to form an association with the first user. The second user may accept or reject the invitation. According to one embodiment, if the second user rejects the invitation, a one-way association may be formed between the first user and the second user. According to another embodiment, if the second user rejects the association, no association may be formed between the two users. Also, an association between two profiles may comprise an association automatically generated in response to a predetermined number of common entries, aspects, or elements in the two members' profiles. In one embodiment, a member profile may be associated with all of the other member profiles comprising a predetermined number or percentage of common entries, such as interests, hobbies, likes, dislikes, employers and/or habits. Associations designated manually by members of the social network, or associations designated automatically based on data input by one or more members of the social network, may be referred to as user established associations.

Examples of social networks include, but are not limited to, facebook, twitter, myspace, linkedin, and other systems. The exact terminology of certain features, such as associations, fans, profiles, etc. may vary from social network to social network, although there are several functional features that are common to the various terms. Thus, a particular social network may have more of less of the common features described above. In terms of the following disclosure, generally the use of the term “social network” encompasses a system that includes one or more of the foregoing features or their equivalents.

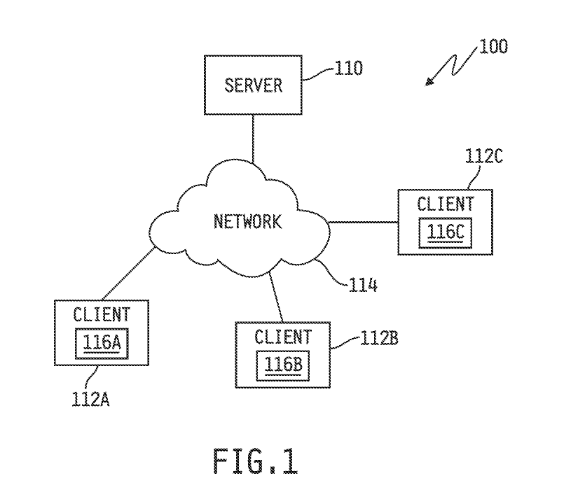

FIG. 1 is a high-level block diagram of a computing environment 100 according to one embodiment. FIG. 1 illustrates server 110 and three clients 112 connected by network 114. Only three clients 112 are shown in FIG. 1 in order to simplify and clarify the description. Embodiments of the computing environment 100 may have thousands or millions of clients 112 connected to network 114, for example the Internet. Users (not shown) may operate software 116 on one of clients 112 to both send and receive messages network 114 via server 110 and its associated communications equipment and software (not shown).

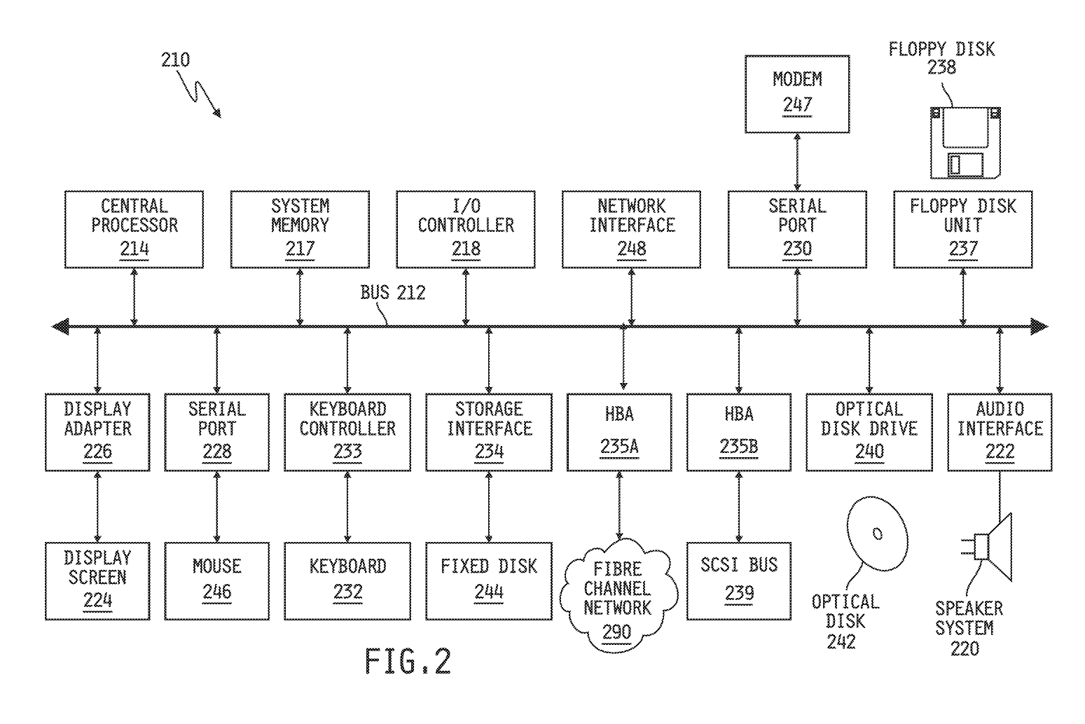

FIG. 2 depicts a block diagram of computer system 210 suitable for implementing server 110 or client 112. Computer system 210 includes bus 212 which interconnects major subsystems of computer system 210, such as central processor 214, system memory 217 (typically RAM, but which may also include ROM, flash RAM, or the like), input/output controller 218, external audio device, such as speaker system 220 via audio output interface 222, external device, such as display screen 224 via display adapter 226, serial ports 228 and 230, keyboard 232 (interfaced with keyboard controller 233), storage interface 234, disk drive 237 operative to receive floppy disk 238, host bus adapter (HBA) interface card 235A operative to connect with Fibre Channel network 290, host bus adapter (HBA) interface card 235B operative to connect to SCSI bus 239, and optical disk drive 240 operative to receive optical disk 242. Also included are mouse 246 (or other point-and-click device, coupled to bus 212 via serial port 228), modem 247 (coupled to bus 212 via serial port 230), and network interface 248 (coupled directly to bus 212).

Bus 212 allows data communication between central processor 214 and system memory 217, which may include read-only memory (ROM) or flash memory (neither shown), and random access memory (RAM) (not shown), as previously noted. RAM is generally the main memory into which operating system and application programs are loaded. ROM or flash memory may contain, among other software code, Basic Input-Output system (BIOS) which controls basic hardware operation such as interaction with peripheral components. Applications resident with computer system 210 are generally stored on and accessed via computer readable media, such as hard disk drives (e.g., fixed disk 244), optical drives (e.g., optical drive 240), floppy disk unit 237, or other storage medium. Additionally, applications may be in the form of electronic signals modulated in accordance with the application and data communication technology when accessed via network modem 247 or interface 248 or other telecommunications equipment (not shown).

Storage interface 234, as with other storage interfaces of computer system 210, may connect to standard computer readable media for storage and/or retrieval of information, such as fixed disk drive 244. Fixed disk drive 244 may be part of computer system 210 or may be separate and accessed through other interface systems. Modem 247 may provide direct connection to remote servers via telephone link or the Internet via an internet service provider (ISP) (not shown). Network interface 248 may provide direct connection to remote servers via direct network link to the Internet via a POP (point of presence). Network interface 248 may provide such connection using wireless techniques, including digital cellular telephone connection, Cellular Digital Packet Data (CDPD) connection, digital satellite data connection or the like.

Many other devices or subsystems (not shown) may be connected in a similar manner (e.g., document scanners, digital cameras and so on). Conversely, all of the devices shown in FIG. 2 need not be present to practice the present disclosure. Devices and subsystems may be interconnected in different ways from that shown in FIG. 2. Operation of a computer system such as that shown in FIG. 2 is readily known in the art and is not discussed in detail in this application. Software source and/or object codes to implement the present disclosure may be stored in computer-readable storage media such as one or more of system memory 217, fixed disk 244, optical disk 242, or floppy disk 238. The operating system provided on computer system 210 may be a variety or version of either MS-DOS® (MS-DOS is a registered trademark of Microsoft Corporation of Redmond, Washington), WINDOWS® (WINDOWS is a registered trademark of Microsoft Corporation of Redmond, Washington), OS/2® (OS/2 is a registered trademark of International Business Machines Corporation of Armonk, New York), UNIX® (UNIX is a registered trademark of X/Open Company Limited of Reading, United Kingdom), Linux® (Linux is a registered trademark of Linus Torvalds of Portland, Oreg.), or other known or developed operating system.

Moreover, regarding the signals described herein, those skilled in the art recognize that a signal may be directly transmitted from a first block to a second block, or a signal may be modified (e.g., amplified, attenuated, delayed, latched, buffered, inverted, filtered, or otherwise modified) between blocks. Although the signals of the above described embodiments are characterized as transmitted from one block to the next, other embodiments of the present disclosure may include modified signals in place of such directly transmitted signals as long as the informational and/or functional aspect of the signal is transmitted between blocks. To some extent, a signal input at a second block may be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

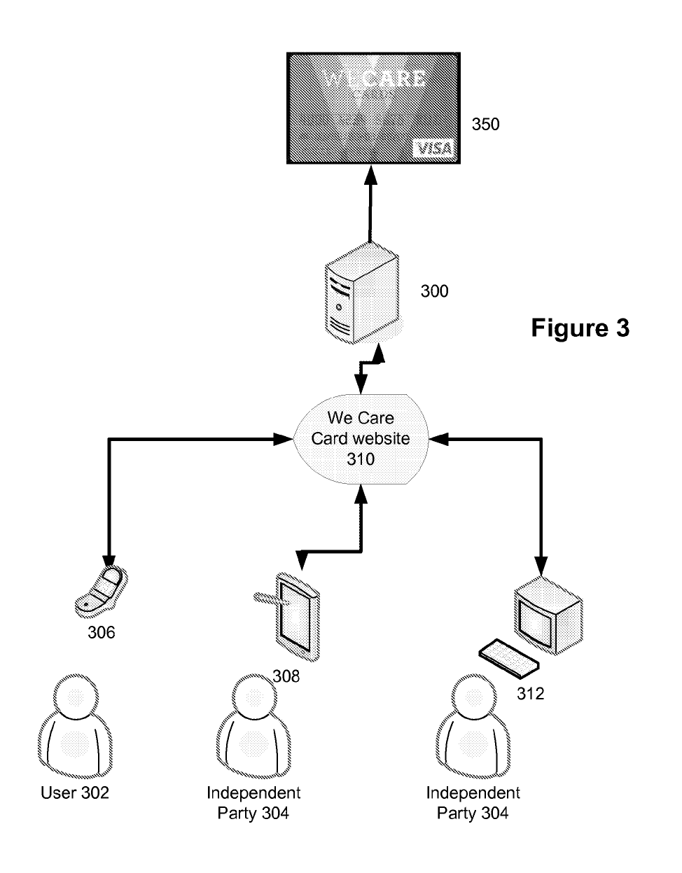

In an exemplary embodiment of the invention shown in FIG. 3, server 300 facilitates both the creation of debit card 350 by initiating user 302, and the reloading of debit card 350 by independent parties 304. For example, server 300 creates a debit card account associated with debit card 350, and transfers or credits funds from independent parties 304 to the account associated with debit card 350. One method of enabling this procedure is for initiating user 302 to specify the recipient of debit card 350. For example, the initiating user 302 submits a request to server 300 for the creation of debit card 350, the request including a recipient identifier that identifies the recipient. In response, server 300 generates an account identifier that identifies the account associated with debit card 350, and for example transmits the account identifier to initiating user 302. The account identifier could include any element for uniquely identifying the debit account, such as an account number, the name and/or address of the recipient, a physical item having encoded information, etc. Initiating user 302 then for example provides information identifying the account to one of independent parties 304. For example, a link sent via e-mail, text message, SMS, or a button on a social network post may initiate a message from independent party 304 to server 300 to start a transfer of funds from independent party 304 to debit card 350. For example, each of independent parties 304 may make a separate request to server 300 for funds to be applied or transferred to the account of debit card 350. These requests may include, for example, at least the account identifier associated with debit card 350. Such a link may included encoded identification of the target individual and/or account, as well as encoded identification of the individual transferring the funds. Such encoding may encompass encrypted information, hash values of numbers or text associated with a person or account, or other encoding scheme. The link itself may include a string or portion that when activated by browser software or similar mechanisms, identify the underlying text or number.

Server 300 plays an important role in the transactions contemplated by the embodiments of the present invention. In accounting for financial transactions, it is usually necessary to identify the parties involved in a particular transaction. In the electronic commerce world, typically financial organizations rely on multiple items of identification to verify identity, called multi-factor authentication. The three factors primarily used involve information that an individual knows, information on a thing that an individual possesses, and information derived from a characteristic of the individual. It may also be possible to have a variant on multi-factor authentication based on separate and distinct classes of information from those three factors, for example information an individual knows about her family as opposed to information an individual knows about her employment. Server 300 may have direct access to multi-factor information (e.g., a user database with security profile information) or indirect access to such information (e.g., an application program interface to a trusted third party). Such a trusted third party may be a financial institution, a medical institution, another member based group having relevant factor information, and/or a combination of two or more third parties that combined provide a sufficiently high authentication level. Additionally, things an individual has may include security code generating devices, computers and/or smartphones, encryption keys, etc. that may be used to authenticate a communication by an individual. Also, biometric information about an individual may identify an individual, such as a scan from a finger print reader, a scan from a retinal scanner, or even a photograph of an individual. A piece or collection of information that aids in the identification of an individual, typically stored in electronic form, is termed a token. Through use of the multi-factor information, server 300 may be able to reliably identify an individual accessing server 300, creating an identity module that processes and optionally stores authentication information, and transmits such identifying information as a token to provide authentication for a transaction. Such an authentication process may be used for both a donating user as well as a recipient.

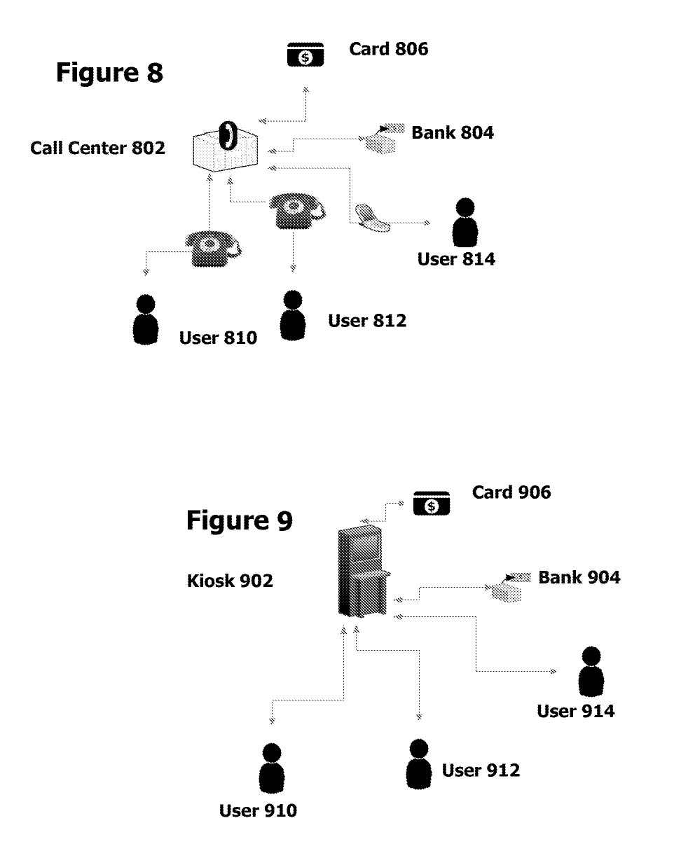

A debit card, in one embodiment of the invention, may be created by user 302 visiting WeCare Card website 310 and initiating the creation of the debit card (not shown). For example, user 302 may sponsor a debit card to provide funds for a friend in a difficult situation (e.g., stranded in a remote location because a family member became ill while on a trip). User 302 may fund the card by a conventional transaction, in one embodiment by an e-commerce exchange through a transaction processing module which is part of website 310, in an alternative embodiment by submitting cash into a kiosk (shown in FIG. 9) that confirms the receipt of cash to web site 310. WeCare Card website 310 then initiates the creation of the physical debit card and arranges for the physical debit card to be delivered (e.g., by overnight delivery) to the friend/recipient. In another embodiment, WeCare Card website 310 sends a message (e.g. by mobile phone text message or electronic mail) to the recipient with identifying information so that the recipient may obtain the debit card from another kiosk, automatic teller machine (ATM) terminal, internet terminal, bank teller, or banking facility. In these various embodiments, the recipient obtains the debit card and is able to use the funds associated with the card without having to attend to setting up an account or otherwise dealing with the financial institution that provides the debit card account.

In addition to providing basic gift card functionality, WeCare Card website 310 also facilitates independent parties 304 providing funds to the debit card for the recipient, either initially for a closed loop debit card, or after the delivery of the card for a reloadable debit card. In one embodiment, WeCare Card website 310 provides a listing of available debit cards for initial funding or additional reloading. Such a listing may be alphabetically arranged, geographically arranged, or searchable so that individuals may visit WeCare Card website 310, view the available debit cards and their associated recipients, and initiate an e-commerce transaction to provide additional funding to the debit card. In addition, in some embodiments, user 302 or independent parties 304 may specify particular areas of concern or interest to them, e.g., homelessness, single parenting, cancer, children, and WeCare Card website 310 pushes notifications to user 302 when such identified concerns become a subject of a campaign involving a WeCare Card. Such campaigns may be self identified, or may be determined by search and evaluation of campaign pages. In another embodiment, WeCare Card website 310 provides a description of the debit card recipient and an associated link to a funding section of website 310 so that user 302, or any of the independent parties 304, may post the description and link to a social network to assist raising funds for the recipient. In another embodiment, WeCare Card website 310 provides user 302 or independent parties 304 to send electronic mail messages, text messages, SMS messages, instant messages, and/or social network messages containing the description and/or the link. In further embodiments, the functions described in this paragraph are conducted through a mobile device app, e.g. using cell phone 306 or tablet 308, rather than through conventional computer 312. In still further embodiment, the functions described in this paragraph are conducted through a kiosk which may have a cash deposit or ATM terminal for receiving funding.

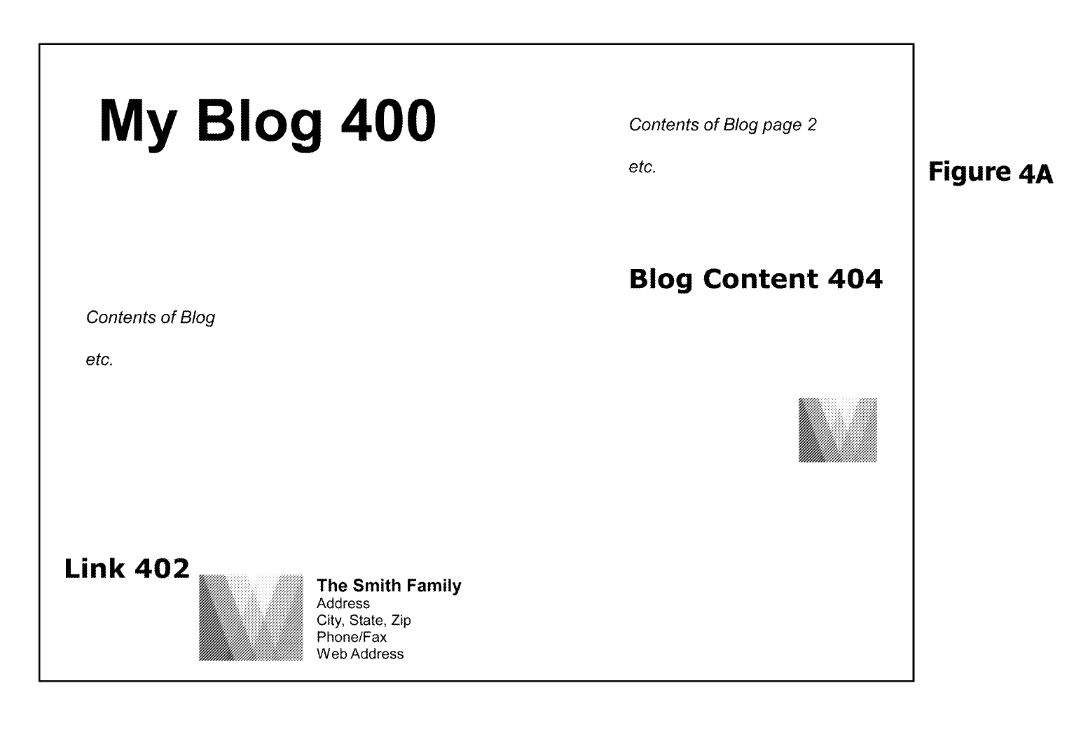

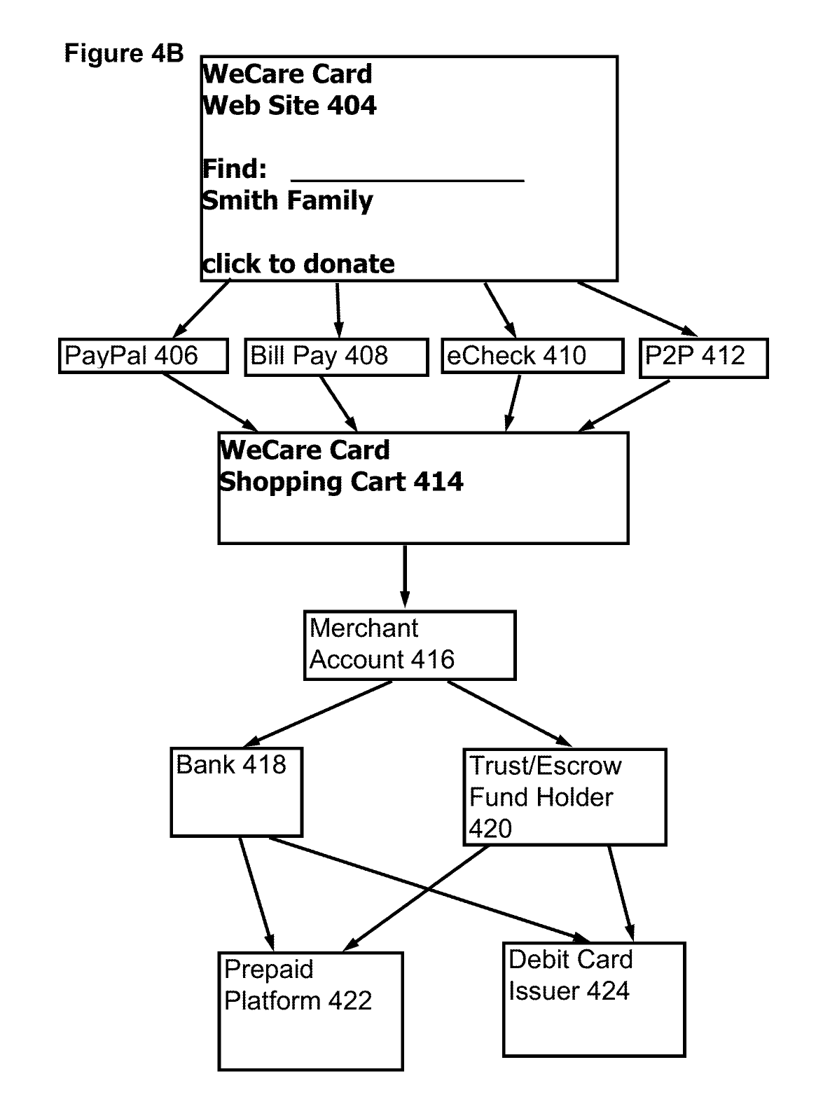

FIG. 4, comprising FIGS. 4A and 4B, illustrates a workflow of the operation of an embodiment of the present invention. The starting point may be a blogger writing about a situation (e.g., see discussion of FIG. 5 below), in this example about the Smith family, wherein someone has initiated a “WeCare Card” for the Smith Family. The blog site, for example a social network, may include a deep link to the corresponding page or pages for the Smith family at the WeCare Card web site. The individual may check to donate to the Smith family card by clicking on a donate button of that particular page of the WeCare Card website, and invoke an e-commerce process. In the illustrated work flow, a payment process such as PayPal, Bill Pay, eCheck, P2P, or other similar e-commerce payment system to transfer funds from a personal bank account to the WeCare Card website shopping cart, from which funds are transferred to a merchant account and to a bank or other trust/escrow fund holder. The WeCare Card shopping cart sends the funds with an identification of the target recipient debit card, which may be reloaded by the prepaid platform, or if not yet issued then the funds from the shopping cart may fund the issuance of the debit card.

FIG. 5 illustrates a situation suitable for such a workflow, wherein a family may need assistance because of a house fire. A family member or another individual may start the WeCare Card funding process by interacting with social media to notify multiple individuals of the house fire and the family in need of emergency funds, for example by writing a blog entry about the house fire and the individuals in distress. Concurrently, someone starts a WeCare Card for the family at the WeCare Card website so that the social media blog can reference the deep link to the family's WeCare Card page. Alternatively, the blog writer may independently write about the family's plight, and a reader may start a WeCare Card for the family and post a donation link as a comment to the blog entry. In such an alternative embodiment, the identity of the WeCare Card recipient would need to be identified before a loaded debit card is provided to the recipient, such as through one of the above described identity modules. In either event, multiple readers of the blog entry may follow the link and contribute funds to the family's debit card.

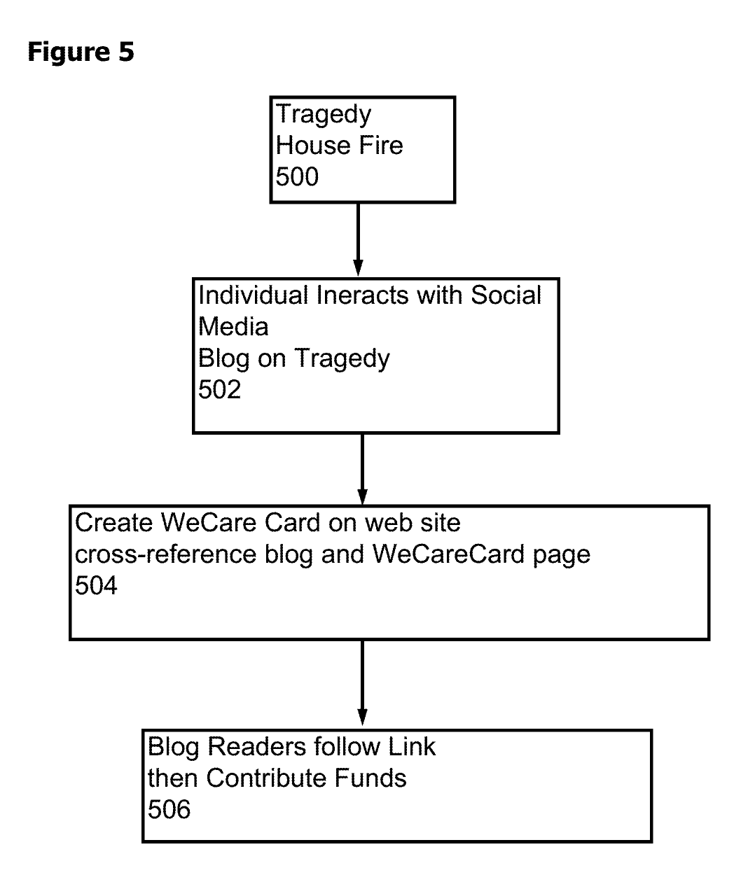

FIG. 6 illustrates how the social situation of FIG. 5 and the network schematic of FIG. 4 may interact in one embodiment of the invention. An individual with an injury, e.g. a broken leg, may be noticed by another individual, the helper, who offers help. Within a social network, the helper can publicize the plight of the person with the broken leg. That helper, or others, may then start publishing blogs of the plight of the person with the broken leg and then associating those discussions with links to the WeCare Card website (WCCW). Such links may be either a general link to WCCW (requiring a follower of the link to look for the injured individual) or an embedded link that takes the follower directly to the injured person's specific WCCW page or pages. Anyone visiting the injured person's WCCW page(s) may invoke the WCCW shopping cart, a P2P process, or other e-commerce procedure to get funds to a merchant account. Once in the merchant account, the funds may optionally stay in an escrow or trust account (in anticipation of the issuance of a debit card) or directly reload an existing debit card that is associated with the injured person. Through this process, multiple persons may be notified of the distress of the injured person and take steps to provide needed funds to that person through e-commerce processes without having to set up any special fund transfers.

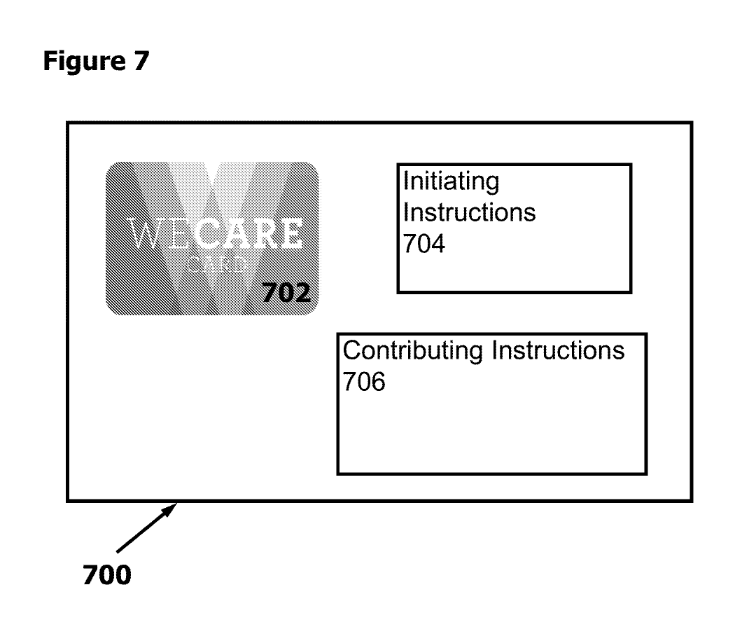

In one embodiment, shown in FIG. 8, WeCare Card call center 802 is connected to conventional telephony networks, and may be contacted by users 810, 812, and 814 through telephony exchanges, e.g., land line telephones or mobile phones. Call center 802 is also in communication with financial institutions, such as bank 804 and card 806, so that when one of users 810, 812, or 814 opts to become an initiator, call center 802 may obtain the information about the initiator, the recipient, and fund the debit card. Subsequently, other ones of users 810, 812, or 814 may contact call center 802 and opt to become a contributor. In one embodiment, the recipient is identified by name and the contributors specify the individual to be the recipient over the telephone. In other embodiments, the initiator starts the process for obtaining a kit having a WeCare Card debit card, information about activating the debit card for a donor, and several additional information cards containing identifying information about the debit card and the funding mechanism. Such information cards include, for example, the telephone number of call center 802, and a unique code for the debit card. Contributors would receive this information, telephone call center 802 and express the desire to fund the debit card identified by the unique code. Call center 802 may obtain funding information from each contributor, e.g. a credit card number and credentials acceptable by card 806, or a bank account number and routing number for bank 804. Additionally, call center 802 may confirm the desire to contribute to the recipient by identifying the recipient to the contributor. Assuming that the recipient is acceptable to the contributor, and the contributor's funding information is valid, the contributor may thus further fund the debit card for the recipient.

When the recipient receives the WeCare Card debit card, the recipient may also be provided with activation materials. Delivery may be by hand, for example when the initiator obtains a kit and then gives the WeCare Card debit card to the recipient on a visit and includes activation materials. Alternatively, if the initiator started the process by telephoning call center 802 and identified the recipient, call center 802 would then send the WeCare Card debit card to the recipient, for example by post, express delivery, or special delivery. As a further alternative, call center 802 may provide the recipient with information by which the recipient could go to a bank or kiosk and have the WeCare Card debit card produced. Such activation materials may include a magnetically or visually encoded strip, bar, or section that could be scanned, read, or otherwise detected by a machine. Activation materials may alternatively include a code or series of codes that would be used with a particular interface to identify recipient and confirm the receipt of the WeCare Card debit card.

Similarly, FIG. 9 shows an embodiment of the system of the present invention being deployed using kiosks. Kiosk 902 is in communication with bank 904 and card 906 to allow users 910, 912, and 914 to participate in the funding of a WeCare Card debit card 906. In one embodiment, the recipient is identified by name and the contributors specify the individual to be the recipient by typing into kiosk 902. In other embodiments, the initiator starts the process for obtaining a kit having the debit card, information about activating the debit card for a donor, and several additional information cards containing identifying information about the debit card and the funding mechanism. Such information cards include, for example, the location(s) of kiosk 902, and a unique code for the debit card. Contributors receive this information, interact with kiosk 902, for example by typing into a keyboard/display combination or talking into a microphone and/or responding to touch screen information. Such contributors interact with kiosk 902 to express the desire to fund the WeCare Card debit card identified by the unique code. Kiosk 902 may obtain funding information from each contributor, e.g. a credit card number and credentials acceptable by card 906, the insertion of a physical card into kiosk 902, or a bank account number and routing number for bank 904. Additionally, kiosk 902 may confirm the desire to contribute to the recipient by identifying the recipient to the contributor. Assuming that the recipient is acceptable to the contributor, and the contributor's funding information is valid, the contributor may thus further fund the debit card for the recipient.

In an exemplary embodiment of the invention shown in FIG. 3, server 300 facilitates both the creation of debit card 350 by one or more initiating user 302, and the reloading of debit card 350 by one or more independent parties 304. One method of enabling this procedure is for initiating user 302 to specify the recipient of debit card 350, then for initiating user 302 to provide further information to WeCare Card website 310 about the recipient of debit card 350, for example, by specifying location, category, or other information. Further, each recipient may also have an associated blog, for example on WeCare Card website 310, which allows individuals to post updates and comments. Then, one of independent parties 304 may use a search facility of server 300 to enter search criteria and locate a recipient of interest, either by matching location/category/etc. information of WeCare Card website 310 or from searching an associated blog. Additionally, independent party 304 may also specify interests by indicating specific criteria associated with a recipient, via interest specification or blog searches, for which notification should be sent. For example, a link sent via e-mail, text message, SMS message, social network message, or a button on a social network post may appear to independent party 304, allowing independent party 304 to activate the link and access server 300 to start a transfer of funds from independent party 304 to an instance of debit card 350 associated with a recipient having matching interests.

A debit card, in one embodiment of the invention, may be created by user 302 visiting WeCare Card website 310 and initiating the creation of a WeCare Card debit card (not shown). For example, user 302 may sponsor a debit card to provide funds for a friend in a difficult situation (e.g., stranded in a remote location because a family member became ill while on a trip). User 302 may fund the card by a conventional transaction, in one embodiment by an e-commerce exchange through website 310, in an alternative embodiment by submitting cash into a kiosk (not shown in FIG. 3) that confirms the receipt of cash to web site 310. WeCare Card website 310 then initiates the creation of the physical debit card and arranges for the physical debit card to be delivered (e.g., by overnight delivery) to the friend/recipient. In another embodiment, WeCare Card website 310 sends a message (e.g. by mobile phone text message or electronic mail) to the recipient with identifying information so that the recipient may obtain the debit card from another kiosk, automatic teller machine (ATM) terminal, internet terminal, bank teller, or banking facility. Optionally, WeCare Card website 310 may obtain identifying information regarding the recipient of debit card 350 prior to, concurrently with, or after delivering debit card 350. In one embodiment, a charge card, driver's license, library card, or other identifying card may be scanned or otherwise observed to determine if the card or license uniquely identifies the individual. In another embodiment, initiating user 302 may be provided a token (either physical or electronic) that the recipient is required to present to obtain debit card 350. Thus, initiating user 302 would need to deliver the token to the recipient, thus providing a further level of authentication. In these various embodiments, the recipient obtains the debit card and is able to use the funds associated with the card without having to attend to setting up an account or otherwise dealing with the financial institution that provides the debit card account.

In addition to providing basic gift card functionality, WeCare Card website 310 also facilitates independent parties 304 providing funds to the debit card for the recipient, either initially for a closed loop debit card, or after the delivery of the card for a reloadable debit card. In one embodiment, WeCare Card website 310 provides a listing of available debit cards for initial funding or additional reloading. Such a listing may be alphabetically arranged, geographically arranged, or searchable so that individuals may visit WeCare Card website 310, view the available debit cards and their associated recipients, and initiate an e-commerce transaction to provide additional funding to the debit card. In another embodiment, WeCare Card website 310 provides a description of the debit card recipient and an associated link to a funding section of website 310 so that user 302, or any of the independent parties 304, may post the description and link to a social network to assist raising funds for the recipient. Further embodiments allow for user 302 or 304 to logon to WeCare Card website 310 via a social media account, with the additional ability to obtain photos or comments/posts from the social network to populate a campaign page in WeCare Card website 310, and to direct social media posts from one social network to be sent as a message. In another embodiment, WeCare Card website 310 provides user 302 or independent parties 304 with the ability to send electronic messages containing the description and/or the link; and to obtain campaign statuses and edit/update campaigns. In further embodiments, the functions described in this paragraph are conducted through a mobile device app, e.g. using cell phone 306 or tablet 308, rather than through conventional computer 312. In still further embodiment, the functions described in this paragraph are conducted through a kiosk which may have a cash deposit or ATM terminal for receiving funding. In still further embodiments, some aspects of the process described above occur in a system having a call center such as described in relation to FIG. 8, others over a kiosk such as described in relation to FIG. 9, and still others over a web site such as described in relation to FIG. 3.

In another embodiment of the present invention, debit card 350 may be sold through conventional retail, mail order, telephone, or web purchasing systems without a specific individual recipient. In this embodiment, user 302 obtains debit card 350 from a conventional delivery system for example a retail store. The packaging of debit card 350 may include instructions, or reference to a telephone number, kiosk location, or web site providing such instructions, so that user 302 may set up the recipient information and optionally provide some initial funding of the card. If desired, user 302 may engage in activities to encourage independent parties 304 to provide funds for card 350. User 302 may then give debit card 350 to the recipient, and the recipient may activate the card by contacting an authentication authority, such as server 300, WeCare Card website 310, Call Center 802, and/or Kiosk 902. Optionally, the authentication authority may invoke an identity module to identify and categorize the recipient. In further embodiments, the authentication authority, whether server 300, WeCare Card website 310, Call Center 802, and/or Kiosk 902, may include Application Program Interfaces (or “API'”s) to other trusted systems, for example ones that may use multi-factor authentication to substantiate identification information from the recipient. In one embodiment, WeCare Card website 310 may have an API to a financial institution, such that the recipient may logon to the financial institution web site, using conventional multi-factor authentication. By virtue of the success of the logon, the API may create a token verifying the logon which may be considered as a verification of the individual, assuming that the financial institution is a trusted source. Such a token may be sent as part of an electronic message to identify the sender, alternatively such a token may be stored on an individual's electronic device as an identifying file in a manner similar to a cookie, so that a future interaction with software running on a particular electronic device may access the file and provide suitable identifying information. In another embodiment, WeCare Card website 310 may have software configured to utilize a social network's integration capabilities or APIs to automatically allow information to flow from the social network's systems to or from financial institutions' or WeCare Card's systems to enhance the ability to share campaigns across the websites and servers, authenticate the identity of donors & recipients through the data known by those parties about donors and recipients, etc.

In further embodiments, the functionality of WeCard Card website 310 may be incorporated into another software platform, for example into a social network (not shown). As part of a social network, server 300 may have access to sufficient identity information that a user having social network credentials may be sufficient to providing funding to debit card 350. Alternatively, a user having social network credentials may only have a partial amount of credentials necessary to activate an account. In the case of a partial amount of credentials, an API may use the partial credentials to start an authentication process with another party (e.g., a financial institution) to complete identification and either authorize funding to debit card 350, or to activate debit card 350 for the recipient. Also, user 302 may create a page for the particular debit card 350 and its recipient with the purpose of encouraging the friends and/or followers of user 302 to provide funds for debit card 350.

In further embodiments, the functionality of WeCare Card website 310 may be incorporated into an e-commerce software platform (not shown). As part of an e-commerce network or website, user 302 may purchase debit card 350 through the mechanisms of the e-commerce network or website. User 302 may specify delivery of debit card 350 to user 302, the recipient, or independent party 304 so that independent party 304 may deliver debit card 350 to recipient. If the recipient is a member of the e-commerce network or website, the recipient may be able to activate debit card 350 by providing credentials to the e-commerce network or website. Depending on the functionality of the e-commerce network or website, user 302 may be able to promote providing funds to debit card 350 via messaging or other communication mechanisms, for example recommendations and/or product reviews, such that potentially interested contributors receive the message regarding contributing to the recipient—either automatically through pushing such a recommendation or review to the potential contributor, or passively by providing search terms that potential contributors would likely use.

In still another embodiment, the functionality of WeCare Card website 310 may be incorporated into a financial services software platform. As part of a financial services platform, if user 302 has credentials with the financial services platform then identification should be reliably confirmed for transactions such as funding or activating debit card 350. In one such embodiment, WeCare Card website 310 includes an API that obtains an identity token for the user so that a contributor and/or a recipient may be associated with a transaction involving a particular debit card 350.

WeCare Card website 310 may have additional modules for obtaining identity information and authentication. In one embodiment, WeCare Card website 310 includes an API that interfaces with drivers on client machines to obtain authentication information. For example, user 302 may have a personal computer or smartphone with a connection for a connected token (e.g., a USB token, a smartcard, magnetic strip reader, audio port token, etc.), a user interface for entry of a displayed passcode (e.g., sequence-based, time-based, or a challenge-reply generated display token), or a soft token (e.g., a cookie, an secure socket layer (SSL) client certificate, or an application). In still another embodiment, WeCare Card website 310 further includes an API to call center 800 and/or kiosk 900 so that authentication provided over call center 800 and/or kiosk 900 may be obtained for processing a particular transaction.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A server for providing an interface for a multi-source debit card, said server comprising:
a processor adapted for connection to and communication over a network;
memory associated with said processor; and
transaction processing module, said transaction processing module being stored in said memory and executable by said processor to allow a first party to engage in an electronic commerce procedure to create a debit card for a second party, said transaction processing module including further funding module stored in said memory and executable by said processor to allow a third party, the third party being separate and distinct from the first party and the second party, to provide funding for the debit card.

2. The server of claim 1 further comprising identity module being stored in said memory and executable by said processor to authenticate the identity of a party providing funds for the debit card.

3. The server of claim 2 further comprising a token module stored in said memory and executable by said processor to enable said processor to create a token based on information provided by said identity module, said token capable of being one of associated with a message or stored in a file.

4. The server of claim 2 wherein said identity module includes an application program interface structured and arranged to execute on a device connected to the network and when executed obtain an identity token from a trusted source over the network.

5. The server of claim 1 further comprising a social network module stored in said memory and executable by said processor to provide a social network accessible over the network.

6. The server of claim 1 further comprising an electronic commerce module stored in said memory and executable by said processor to provide an electronic commerce platform accessible over the network.

7. The server of claim 1 further comprising a financial services module stored in said memory and executable by said processor to provide a financial services platform accessible over the network.

8. The server of claim 1 further comprising a message module stored in said memory and executable by said processor to enable users to create, send, or post messages about a particular debit card.

9. The server of claim 8 wherein said message module further enables the processor to associate a link with messages relating to a particular debit card.

10. The server of claim 9 wherein said message module further enables the processor to include an encoded reference to the account number of the particular debit card within the link.

11. A method of using a computer to provide an interface for a multi-source debit card, said method comprising the steps of:
providing a web site accessible over a network that identifies a target debit card;
accepting a first payment from a first source over the network for the identified debit card and crediting the first payment to an account associated with the debit card; and
accepting a second payment from a second source over the network for the identified debit card and crediting the second payment to the account associated with the debit card.

12. The method of claim 11 wherein said accepting step further includes transmitting said account identifier to a first party.

13. The method of claim 11 further comprising the step of authenticating the identity of a party providing funds for the debit card.

14. The method of claim 11 further comprising the step of creating a token based on information provided by said identity module, said token capable of being one of associated with a message or stored in a file.

15. The method of claim 11 wherein after creating the token, an application program interface is structured and arranged to execute on a device connected to the network and when executed obtain an identity token from a trusted source over the network.

16. The method of claim 11 further comprising the step of providing one of a social network, electronic commerce platform, and financial services platform; the social network, electronic commerce platform, and financial services platform being accessible over the network.

17. The method of claims 11 further comprising the step of enabling users to create, send, or post messages about a particular debit card.

18. The method of claim 17 further comprising the step of associating a link with messages relating to a particular debit card.

19. The method of claims 18 wherein the an encoded reference to the account number of the particular debit card is included within the link.
